(19) United States
(12) Patent Application Publication
(10) Pub. No.: US 2025/0070229 A1
(43) Pub. Date: Feb. 27, 2025

(54) ELECTROLYTE AND BATTERY INCLUDING ELECTROLYTE

(71) Applicant: Murata Manufacturing Co., Ltd., Nagaokakyo-shi, Kyoto-fu (JP)

(72) Inventor: Yuji KINTAKA, Nagaokakyo-shi (JP)

(21) Appl. No.: 18/947,390

(22) Filed: Nov. 14, 2024

Related U.S. Application Data
(63) Continuation of application No. PCT/JP2023/026723, filed on Jul. 21, 2023.

(30) Foreign Application Priority Data
Jul. 22, 2022 (JP) 2022-117416
Dec. 2, 2022 (JP) 2022-193419

(51) Int. Cl. H01M 10/056; H01M 10/0525

(52) U.S. Cl. CPC H01M 10/056; H01M 10/0525; H01M 2300/0028; H01M 2300/0071; H01M 2300/0085

(57) ABSTRACT

An electrolyte including: a porous insulator having a pore; and a medium having two nitrile groups and a metal salt that are disposed in the pore, wherein the metal salt is at least one of an alkali metal salt and an alkaline earth metal salt, and a molar ratio of the medium to the metal salt (medium/metal salt) is 0.1 to 4.0.

### CROSS REFERENCE TO RELATED APPLICATIONS

The present application is a continuation of International application No. PCT/JP2023/026723, filed Jul. 21, 2023, which claims priority to Japanese Patent Application No. 2022-117416, filed Jul. 22, 2022, and Japanese Patent Application No. 2022-193419, filed Dec. 2, 2022, the entire contents of each of which are incorporated herein by reference.

### TECHNICAL FIELD

The present disclosure relates to an electrolyte and a battery including the electrolyte.

### BACKGROUND ART

Batteries, including an air battery, a fuel battery, and a secondary battery, are used for various applications. A battery includes a positive electrode and a negative electrode, and has an electrolyte responsible for ion transport between the positive electrode and the negative electrode.

For example, Patent Document 1 discloses an ion conductive composite (electrolyte) including an insulating structure formed of a porous coordination polymer having a metal salt coordination unsaturated site, and an anion represented by [R—SO₂—N—SO₂—R′]⁻ (R and R′ represent a fluorine atom or a fluoroalkyl group) and a metal cation (for example, Li⁺, Na⁺, or Mg²⁺) that are held in pores of the porous coordination polymer.

In addition, Patent Document 2 discloses an electrolyte modulator that can be used for a metal battery, the electrolyte modulator including: a liquid electrolyte; and a material of a metal-organic framework (MOF) that is incorporated into the liquid electrolyte to form a MOF slurry electrolyte, the MOF being a class of crystalline porous solids constructed from metal cluster nodes and organic linkers, and capable of binding anions, removing ion pairs, and enhancing cation transport upon activation and impregnation of the liquid electrolyte.
Patent Document 1: Japanese Patent No. 6222635
Patent Document 2: Japanese Patent Application Laid-Open No. 2020-508542

### SUMMARY OF THE DISCLOSURE

The present inventor has noticed that there is still a problem to be overcome in the electrolyte, and has found a need to take measures therefor. Specifically, the present inventor has found that there is room for improvement in ionic conductivity of the electrolyte.

The present disclosure has been devised in view of such a problem. That is, a main object of the present disclosure is to provide an electrolyte having more excellent ionic conductivity than before.

The present inventor has attempted to solve the above-described problem by addressing the problem in a new direction rather than addressing the problem in an extension of the prior art. As a result, the present inventor has invented an electrolyte that achieves the main object.

An electrolyte according to an embodiment of the present disclosure includes: a porous insulator having a pore; and a medium having two nitrile groups and a metal salt that are disposed in the pore, wherein the metal salt is at least one of an alkali metal salt and an alkaline earth metal salt, and a molar ratio of the medium to the metal salt (medium/metal salt) is 0.1 to 4.0.

Further, a battery according to an embodiment of the present disclosure includes the above-described electrolyte.

The present disclosure can provide an electrolyte having more excellent ionic conductivity.

### BRIEF EXPLANATION OF THE DRAWINGS

FIG. 1 is a conceptual diagram illustrating an example of a battery according to a second embodiment of the present disclosure.

FIG. 2 is a graph showing a relationship between molar ratio (SN/LiFSI) and ionic conductivity at room temperature.

FIG. 3 is Raman spectrums of electrolytes of Examples 2 and 3, Examples 5 to 7, and Comparative Example 1 at 2220 to 2320 cm⁻¹.

### DESCRIPTION OF THE PREFERRED EMBODIMENTS

Hereinafter, the “electrolyte” and the “battery” including the electrolyte of the present disclosure will be described in more detail with reference to embodiments. While the description is made with reference to the drawings as necessary, the contents shown in the drawings are only schematically and illustratively shown for understanding the present disclosure, and the appearance, the dimensional ratio, and the like can be different from the actual ones.

The various numerical ranges referred to herein are intended to include the lower limit and upper limit numerical values themselves, for example, unless there are specific phrases such as “less than”, “smaller than”, and “greater than”. That is, when a numerical range such as 1 to 10 is taken as an example, it is interpreted as including both the lower limit value “1” and the upper limit value “10”.

In the present specification, that an object member is substantially made of a specific material or that an object member is made of a specific material means that the object member contains the specific material in a ratio of 95 mass % or more, 97 mass % or more, 99 mass % or more, or 100 mass %. For example, that a mesoporous silica is substantially made of silica (SiO₂) means that the mesoporous silica contains silica (SiO₂) in a ratio of 95 mass % or more, 97 mass % or more, 99 mass % or more, or 100 mass %.

In the present disclosure, the “battery” means, in a broad sense, a device from which energy can be extracted using an electrochemical reaction. The “battery”, in a narrow sense, means a device including a pair of electrodes and an electrolyte, particularly a device that charges and discharges along with movement of ions. Examples of the battery include a primary battery and a secondary battery, and more specifically include a lithium battery, a magnesium battery, a sodium battery, and a potassium battery, although they are illustrative only.

In the present disclosure, unless otherwise specified, the “electrolytic solution” refers to an electrolyte according to the present disclosure excluding the porous insulator, and including the metal salt and the medium.

### First Embodiment: Electrolyte

An electrolyte according to a first embodiment of the present disclosure is used, for example, in a battery. That is, the electrolyte described in the present specification corresponds to an electrolyte for a device from which energy can be extracted by utilizing an electrochemical reaction.

As a premise, the electrolyte according to the first embodiment is used for a battery including an electrode made of lithium, magnesium, sodium, or potassium. In particular, the electrolyte is for a battery including a lithium electrode as a negative electrode. Therefore, it can also be said that the electrolyte according to the first embodiment is an electrolyte for a lithium electrode-based battery (hereinafter, also simply referred to as “lithium electrode-based electrolyte”).

Here, the “lithium electrode” used in the present specification, in a broad sense, refers to an electrode having lithium (Li) as an active ingredient (that is, an active material). In a narrow sense, the “lithium electrode” refers to an electrode containing lithium, for example, an electrode containing lithium metal or a lithium alloy, particularly such a lithium negative electrode. Although the lithium electrode may contain a component other than lithium metal or a lithium alloy, in a preferred embodiment, the lithium electrode is an electrode made of a metal body of lithium (for example, an electrode made only of lithium metal having a purity of 90% or more, preferably a purity of 95% or more, and more preferably a purity of 98% or more).

The electrolyte of the first embodiment has Li ion conductivity in the case of a lithium electrode system. The ionic conductivity of the electrolyte of the first embodiment is, for example, a value on the order of 10⁻⁴ S/cm or more at room temperature (for example, 25° C.). The method of measuring ionic conductivity will be described in detail in EXAMPLES.

The electrolyte according to the first embodiment includes: a porous insulator having a pore; and a medium (medium molecule) having two nitrile groups (cyano groups: —CN groups) and a metal salt that are disposed in the pore, wherein the metal salt is at least one selected from the group consisting of an alkali metal salt and an alkaline earth metal salt, and a molar ratio of the medium to the metal salt (medium/metal salt) is 0.1 to less than 0.8 and is 0.8 to 4.0 (that is, 0.1 to 4.0)).

### [Mechanism of Action]

The electrolyte of the embodiment is more excellent in ionic conductivity. Although not bound by a specific theory, the reason is presumed as follows. In the electrolyte of the embodiment, the metal salt and the medium can form a bridge structure in a specific molar ratio (medium/metal salt=0.1 to 4.0). Specifically, the electrolyte of the embodiment can form a bridge structure in which the medium and the positive ion (more specifically, a metal ion) constituting the metal salt are alternately arranged. When the bridge structure is arranged in the pore of the porous insulator, defects (holes) in which metal ions are partly missing are formed, which can be paths through which metal ions are efficiently transported in the electrolyte. Therefore, in the electrolyte of the embodiment, the bridge structure is formed to improve the ionic conductivity of metal ions.

### (Bridge Structure)

In the bridge structure, the medium and the positive ion (metal ion) constituting the metal salt are alternately arranged, and some of the metal ions are missing. The bridge structure will be described in detail with reference to Chemical Formula 1 below:

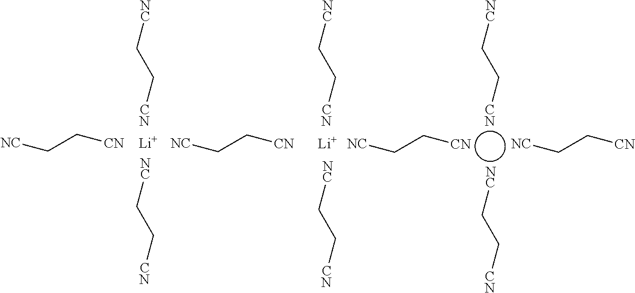

As an example of the electrolyte of the embodiment, Chemical Formula 1 exemplifies an electrolyte containing succinonitrile as a medium and a metal salt constituted by a metal ion Li⁺ (succinonitrile-Li⁺-based electrolyte) in the pores of the porous insulator. In the bridge structure of the succinonitrile-Li⁺-based electrolyte, (the nitrogen atoms of) nitrile groups of succinonitrile are coordinated to Li⁺, succinonitrile and Li⁺ are alternately arranged one-dimensionally, and Li⁺ is partly missing to from defects (dashed circle in Chemical Formula 1). When the bridge structure is viewed from the viewpoint of Li⁺, adjacent Li⁺s are bridged by succinonitrile in the bridge structure. Since Li⁺ defects are present, adjacent Li⁺s with succinonitrile interposed therebetween can move to the defects. As described above, it is considered that Li⁺ can sequentially move in the bridge structure, and thereby the bridge structure contributes to efficient transport of metal ions in the electrolyte, and realizes more excellent ionic conductivity.

In the bridge structure, one-dimensional arrangement means, for example, that succinonitrile and Li⁺ are linearly arranged. However, the arrangement mode of succinonitrile and Li⁺ is not limited thereto. For example, the arrangement of succinonitrile and Li⁺ may be two-dimensional or three-dimensional, and more specifically, the linear arrangement may be curved or branched.

### (Method of Confirming Bridge Structure)

The bridge structure can be confirmed by structural analysis by Raman spectroscopy. As described above, the bridge structure can be constructed by coordinating metal ions of the metal salt to the medium. That is, the metal ion forms a coordinate bond with a specific functional group of the medium, whereby the bridge structure can be constructed. Therefore, the presence of the bridge structure can be confirmed by using microscopic Raman spectroscopy to confirm that “a peak derived from a specific vibration of a coordinate-bonded functional group is shifted to the higher wave number side as compared with the peak derived from the specific vibration of the functional group in the non-coordinated state”.

For example, the presence of the bridge structure of the succinonitrile (SN)—Li⁺-based electrolyte can be confirmed by using microscopic Raman spectroscopy to confirm that “in a Raman spectrum, the peak (Raman scattering peak) derived from CN stretching vibration of the nitrile groups of the medium is shifted to the higher wave number side”. The presence of the bridge structure can be confirmed when the peak assigned to C—N stretching vibration of the nitrile groups coordinated to the metal ion is shifted to the higher wave number side as compared with the peak (known peak) assigned to C—N stretching vibration of the nitrile groups not coordinated to a metal ion.

The method for confirming the bridge structure will be described in detail in Examples.

### (Trigger for Creating Present Disclosure)

When a porous insulator is impregnated with an electrolytic solution to be used for a lithium ion battery, the ionic conductivity is still low. The present inventor has intensively studied the concept of enhancing the ionic conductivity. As a result, the present inventor has found that higher ionic conductivity is obtained when a bridge structure is formed in the pores and metal ions propagate through the bridge structure in the pores, than when only the mechanism that solvated metal ions propagate through the pores works. As a result, the present inventor has arrived at the electrolyte of the embodiment, whose ionic conductivity is enhanced by introducing a mechanism that is totally new and not included in the conventional concept: carrier transport by the bridge structure.

### (Molar Ratio (Medium/Metal Salt))

The molar ratio of the medium to the metal salt (medium/metal salt) is 0.1 to 4.0. When the molar ratio is less than 0.1 or greater than 4.0, the ionic conductivity is reduced. From the viewpoint of further improving the ionic conductivity of the electrolyte, the lower limit value of the molar ratio is preferably 0.2 and more preferably 0.3, and the upper limit value of the molar ratio is preferably 2.0, more preferably 1.5, still more preferably 1.2, and particularly preferably 1.0. Any upper and lower limit values can be selected from the plurality of suitable numerical ranges and combined to obtain a suitable numerical range of the molar ratio (a numerical range including an upper limit value and a lower limit value). For example, the molar ratio is preferably 0.2 to 2.0.

Especially, the molar ratio (SN/LiFSI) is preferably 0.2 to 2.0, and more preferably 0.4 to 1.0.

### —Method for Determining Molar Ratio (Medium/Metal Salt)—

The molar ratio (medium/metal salt) can be determined by the addition amounts (molar ratio in the raw material state) of the medium and the metal salt constituting the electrolyte according to the embodiment. Alternatively, the molar ratio (medium/metal salt) can also be determined from the electrolyte (as a finished product).

The electrolyte of the embodiment may be a solid electrolyte.

The electrolyte of the embodiment includes a porous insulator, a medium, and a metal salt. The electrolyte of the embodiment may further include components other than these components (porous insulator, medium, and metal salt) as long as the main effects of the present disclosure are exhibited. Hereinafter, these components constituting the electrolyte will be described.

### (Porous Insulator)

The porous insulator has the medium having two nitrile groups and the metal salt that are disposed in the pore thereof. As a result, the electrolyte of the first embodiment easily forms the bridge structure contributing to more excellent ionic conductivity. The porous insulator has pores. For example, the porous insulator is at least one selected from the group consisting of a zeolite and a mesoporous silica.

The porous insulator is preferably a zeolite or a mesoporous silica from the viewpoint of improving the ionic conductivity of the electrolyte. Although not bound by a specific theory, the reason is presumed as follows. When the electrolyte of the embodiment includes at least one (contains at least one) of a zeolite and a mesoporous silica as the porous insulator, it is considered that silanol groups (Si—OH) present on the pore inner wall of the zeolite or the mesoporous silica function as hopping sites for carriers (the positive ion of the metal salt, more specifically Li⁺, etc.). More specifically, it is considered that the protons (H⁺) of the silanol groups and the carriers are exchanged so that the silanol groups function as hopping sites for carriers. Therefore, when the electrolyte includes at least one of a zeolite and a mesoporous silica as the porous insulator, the ionic conductivity of the electrolyte is further improved.

Among the porous insulators, from the viewpoint of improving the ionic conductivity of the electrolyte, the zeolite and the mesoporous silica have a Si/Al ratio of, for example, 5 or more, preferably 15 or more, more preferably 40 or more, further preferably 100 or more, particularly preferably 500 or more, and very particularly preferably 1500 or more. The Si/Al ratio is, for example, 10,000 or less. Any of these upper and lower limit values can be combined to form a numerical range (for example, 5 to 10,000). In the present specification, the Si/Al ratio refers to the molar ratio of Si (silicon atoms) with respect to Al (aluminum atoms) constituting the porous insulator.

When the Si/Al ratio is 5 or more, the zeolite and the mesoporous silica can have more silanol groups on the pore inner wall thereof. In this case, it is considered that more hopping sites for carriers can be present on the pore inner wall of the zeolite and the mesoporous silica, and the ionic conductivity of the electrolyte is further improved.

The Si/Al ratio of the zeolite and the mesoporous silica is measured as follows. The zeolite or mesoporous silica is pulverized such that measurement can be performed, and placed in a nuclear magnetic resonance apparatus (“ECA 400 type FT-NMR apparatus” manufactured by JEOL Ltd.). An NMR spectrum is measured under measurement conditions of a magnetic field strength of 9.2 T and a nuclide: ²⁹Si. The Si/Al ratio is obtained by spectral analysis.

The zeolite or mesoporous silica used for the measurement of the Si/Al ratio can be subjected to measurement not only in the state of a raw material but also in a state of being separated from the finished product (for example, an electrolyte or a battery including an electrolyte (more specifically, a measurement cell battery described later in Examples)).

Examples of commercially available products of zeolite include “HS-690”, “HS-642”, and “HS-320” (cation species: H or Na), each of which is manufactured by FUJIFILM Wako Pure Chemical Corporation, and “HSZ-360HUA”, “HSZ-385HUA”, “HSZ-640HOA”, “HSZ-840HOA”, “HSZ-890HOA”, and “HSZ-980HOA”, each of which is manufactured by Tosoh Corporation. Examples of commercially available products of mesoporous silica include “MCM-41”, “MCM-48”, “SBA-15”, and “SBA-16”, each of which is manufactured by Sigma-Aldrich Co. LLC.

### (Medium)

The medium is an electrically neutral molecule. The medium disperses, dissolves, or forms a solid solution of the metal salt in the electrolyte. The medium is a medium having two nitrile groups (nitrile-based medium). The nitrile-based medium is, for example, at least one selected from the group consisting of succinonitrile (1,2-dicyanoethane), glutaronitrile (1,3-dicyanopropane), and adiponitrile (1,4-dicyanobutane).

When the medium is at least one of these, the medium easily forms the bridge structure with a metal ion constituting the metal salt in the electrolyte. Therefore, in such a case, the electrolyte of the embodiment has further enhanced ionic conductivity.

### (Metal Salt)

The metal salt is at least one selected from the group consisting of an alkali metal salt and an alkaline earth metal salt. Examples of the metal salt include an alkali metal salt (more specifically, a lithium metal salt or the like). Examples of the lithium metal salt include lithium bis(fluorosulfonyl)imide (LiFSI), lithium bis(trifluoromethanesulfonyl)imide (LiTFSI), lithium tetrafluoroborate (LiBF₄), and lithium perchlorate (LiClO₄). Among them, the lithium salt is preferably LiFSI or LiTFSI, and more preferably LiFSI. Examples of the alkali metal ion constituting the alkali metal salt include Li⁺, Na⁺, and K⁺. Examples of the alkaline earth metal ion constituting the alkaline earth metal salt include Mg²⁺. The metal ion (positive ion) constituting the metal salt is preferably Li⁺, K⁺, Na⁺, or Mg²⁺. The negative ion constituting the metal salt is, for example, at least one selected from the group consisting of a bis(fluorosulfonyl)imide ion, a bis(trifluoromethanesulfonyl)imide ion (TFSI ion), a tetrafluoroborate ion, and a perchlorate ion, and preferably at least one selected from the group consisting of a bis(fluorosulfonyl)imide ion and a bis(trifluoromethanesulfonyl)imide ion (TFSI ion).

### (Method for Producing Electrolyte)

An example of the method for producing the electrolyte of the first embodiment will be described. The method for producing the electrolyte of the first embodiment includes the steps of: preparing an electrolytic solution containing a metal salt and a medium (electrolytic solution preparation step); and impregnating a porous insulator having a pore with the electrolytic solution (impregnation step).

### —Electrolytic Solution Preparation Step—

In the electrolytic solution preparation step, an electrolytic solution containing a metal salt and a medium is prepared.

### —Impregnation Step—

In the impregnation step, a porous insulator having a pore is impregnated with the electrolytic solution. As a result, the pores of the porous insulator are filled with the electrolytic solution. When the prepared electrolytic solution is not a liquid at room temperature (25° C.) (for example, solid or pseudo-solid (more specifically, a liquid in which a solid is mixed)), the electrolytic solution can be heated to become a liquid state, and the porous insulator can be impregnated therewith.

### Second Embodiment: Battery

A battery of a second embodiment includes the electrolyte of the first embodiment. The battery of the second embodiment may further include a positive electrode and a negative electrode in addition to the electrolyte.

In the battery of the embodiment, the positive electrode contains a material constituting the positive electrode (more specifically, a positive electrode active material and the like). The negative electrode contains an alkali metal (more specifically, Li, Na, and K) or an alkaline earth metal (more specifically, Mg) as a material constituting the negative electrode (specifically, a negative electrode active material). The negative electrode contains, for example, a simple substance of an alkali metal or an alkaline earth metal (more specifically, a plate, a foil, and a layer) and a compound thereof.

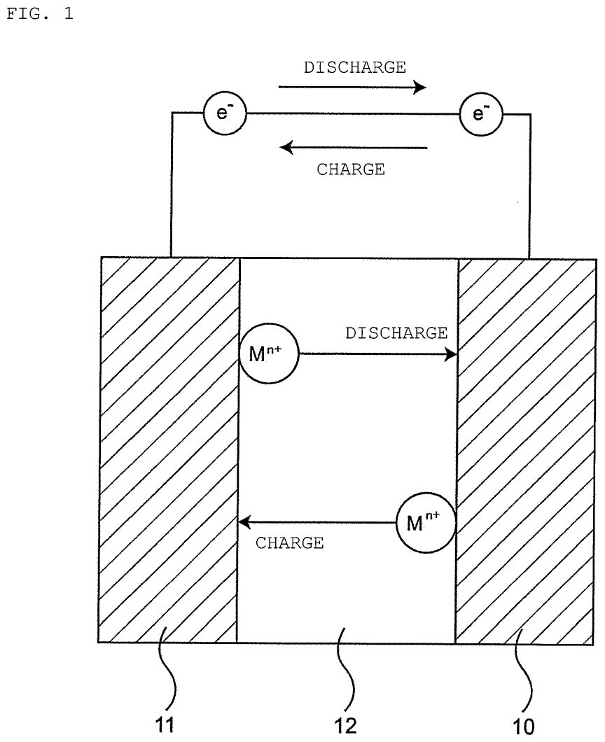

The battery of the embodiment can be configured as a secondary battery. FIG. 1 shows a conceptual diagram in this case. As shown, during charging, metal ions (Mⁿ⁺ (M represents a metal element, and “n” represents a positive integer.): more specifically, Li⁺, Na⁺, K⁺, Mg²⁺, and the like) move from a positive electrode 10 through an electrolyte 12 to a negative electrode 11, thereby converting electrical energy into chemical energy for storage. During discharging, metal ions return from the negative electrode 11 to the positive electrode 10 through the electrolyte 12 to generate electric energy.

The battery of the second embodiment can be used as a driving power source or an auxiliary power source of, for example, a notebook type personal computer, a personal digital assistant (PDA), a mobile phone, a smartphone, a master unit and a slave unit of a cordless phone, a video movie, a digital still camera, an electronic book, an electronic dictionary, a portable music player, a radio, a headphone, a game machine, a navigation system, a memory card, a cardiac pacemaker, a hearing aid, an electric tool, an electric shaver, a refrigerator, an air conditioner, a television receiver, a stereo, a water heater, a microwave oven, a dishwasher, a washing machine, a dryer, a lighting apparatus, a toy, a medical device, a robot, a road conditioner, a traffic light, a railway vehicle, a golf cart, an electric cart, and/or an electric car (including a hybrid car). In addition, the battery can be mounted as, for example, a power source for power storage that is used for buildings such as houses or power generation facilities, or can be used in order to supply electric power thereto. In an electric car, a conversion device that converts electric power supplied thereto into a driving force is generally a motor. Examples of the control device (control unit) that processes information related to vehicle control includes a control device that displays the remaining battery level based on information on the remaining battery level. The battery can also be used in an electric storage device in a so-called smart grid. Such a power storage device can not only supply electric power but also store electric power by receiving electric power supply from other power sources. As the “other power sources”, for example, thermal power generation, nuclear power generation, hydroelectric power generation, a solar battery, wind power generation, geothermal power generation, and/or a fuel cell (including a biofuel cell), or the like can be used.

Although the embodiments of the present disclosure have been described above, typical examples have been only illustrated. Accordingly, those skilled in the art will easily understand that the present disclosure is not limited thereto, and various embodiments are conceivable without changing the spirit of the present disclosure.

For example, the composition of the electrolyte, the raw materials used for production, the production method, the production conditions, the characteristics of the electrolyte, and the configuration or structure of the battery described above are examples, and the present disclosure is not limited to these, and those can be changed appropriately. Examples of the battery include a lithium battery, a magnesium battery, a sodium battery, a potassium battery, an air battery, a fuel battery, and the like.

### EXAMPLES

Hereinafter, the present disclosure will be described more specifically with reference to Examples; however, the present disclosure is not limited to these Examples.

### Example 1

### [1. Preparation of Electrolytic Solution]

### (1-1. Raw Materials)

The following raw materials were used.

### —Porous Insulator: Zeolite—

“HS-320”, manufactured by FUJIFILM Wako Pure Chemical Corporation (crystal system: Y-type, Si/Al ratio=5.5, cation species: H; hereinafter, also referred to as “HS-320(H)”)
“HS-320”, manufactured by FUJIFILM Wako Pure Chemical Corporation (crystal system: Y-type, Si/Al ratio=5.5, cation species: Na; hereinafter, also referred to as “HS-320(Na)”)
“HS-642”, manufactured by FUJIFILM Wako Pure Chemical Corporation (crystal system: mordenite, Si/Al ratio=18, cation species: Na)
“HS-690”, manufactured by FUJIFILM Wako Pure Chemical Corporation (crystal system: mordenite, Si/Al ratio=180, cation species: H
“HSZ-360HUA”, manufactured by Tosoh Corporation (crystal system: Y-type, Si/Al ratio=15, cation species: H)
“HSZ-385HUA”, manufactured by Tosoh Corporation (crystal system: Y-type, Si/Al ratio=100, cation species: H)
“HSZ-640HOA”, manufactured by Tosoh Corporation (crystal system: mordenite, Si/Al ratio=18, cation species: H)
“HSZ-840HOA”, manufactured by Tosoh Corporation (crystal system: ZSM-5, Si/Al ratio=40, cation species: H)
“HSZ-890HOA”, manufactured by Tosoh Corporation (crystal system: ZSM-5, Si/Al ratio=1500, cation species: H)
“HSZ-980HOA”, manufactured by Tosoh Corporation (crystal system: beta, Si/Al ratio=500, cation species: H)

### —Porous Insulator: Mesoporous Silica—

“MCM-41”, manufactured by Sigma-Aldrich Co. LLC
“MCM-48”, manufactured by Sigma-Aldrich Co. LLC
“SBA-15”, manufactured by Sigma-Aldrich Co. LLC
“SBA-16”, manufactured by Sigma-Aldrich Co. LLC

These four mesoporous silicas artificially contain no Al, and are substantially made of silica (SiO₂). Therefore, it is considered that the Si/Al ratio of these mesoporous silicas is at least greater than 10,000.

### —Metal Salt—

Lithium bis(fluorosulfonyl)imide (manufactured by KISHIDA CHEMICAL CO., LTD. (for LBG); hereinafter, also referred to as “LiFSI”)
Lithium bis(trifluoromethanesulfonyl)imide (manufactured by KISHIDA CHEMICAL CO., LTD. (for LBG); hereinafter, also referred to as “LiTFSI”)
Lithium hexafluorophosphate (manufactured by KISHIDA CHEMICAL CO., LTD. (for LBG); hereinafter, also referred to as “LiPF₆” or “LiPF6”)
Lithium tetrafluoroborate (manufactured by KISHIDA CHEMICAL CO., LTD. (for LBG); hereinafter, also referred to as “LiBF₄” or “LiBF4”)
Lithium perchlorate (manufactured by KISHIDA CHEMICAL CO., LTD. (for LBG); hereinafter, also referred to as “LiClO₄” or “LiClO4”)

### —Medium: Nitrile-Based Medium—

Succinonitrile (manufactured by Tokyo Chemical Industry Co., Ltd.; hereinafter, also referred to as “SN”)
Glutaronitrile (manufactured by Tokyo Chemical Industry Co., Ltd.; hereinafter, also referred to as “GLN”)
Adiponitrile (manufactured by Tokyo Chemical Industry Co., Ltd.; hereinafter, also referred to as “AGN”)

### (1-2. Preparation of Solid Electrolyte)

The LiFSI as the metal salt and the succinonitrile SN as the medium were mixed in a molar ratio of (medium/metal salt)=4.0 to prepare an electrolytic solution.

The HS-690 as the porous insulator was dried under vacuum at 300° C. The dried HS-690 was impregnated with the prepared electrolytic solution, and the electrolytic solution was inserted in the pores of the HS-690 to fill the pores with the electrolytic solution. Thus, a powdery solid electrolyte was prepared. This impregnation treatment was performed by manually mixing the electrolytic solution and the porous insulator using a mortar and a pestle. The impregnation amount (volume) of the electrolytic solution was 100% of the micropore volume of the porous insulator (HS-690), which was measured in advance.

The solid electrolyte was prepared in a glove box in an argon atmosphere.

### (1-3. Preparation of Measurement Cell)

The prepared powdery solid electrolyte was pressed at 200 MPa using a uniaxial pressing machine (“CDM-20PA”, manufactured by RIKENKIKI CO., LTD.). As the press mold for pressing, a PET resin die provided with upper and lower punches was used. Specifically, the PET resin die had a cylindrical shape and had a cylindrical through opening along the central axis. The punches had a cylindrical shape, were provided such that they could be inserted into and removed from the through opening of the die, and were provided such that the distal end surfaces (surfaces perpendicular to the insertion direction) of the upper and lower punches faced each other. The powdery solid electrolyte was set in the through opening of the die so that the powdery solid electrolyte was sandwiched between the distal end surfaces of the upper and lower punches. The upper and lower punches were pressed with a uniaxial pressing machine to mold the solid electrolyte. Further, the upper punch and the lower punch provided on the PET resin die were used as blocking electrodes as they were to obtain a measurement cell (a cell for measurement).

The step of preparing the measurement cell was performed in a glove box in an argon atmosphere.

### [2. Measurement Method and Evaluation Method]

### (2-1. Form of Electrolytic Solution)

The appearance of the electrolytic solution (electrolytic solution made of the metal salt and the medium) obtained in the step of preparing the solid electrolyte was visually observed. Furthermore, the behavior of the electrolytic solution was visually observed when the container containing the electrolytic solution was inclined and the liquid surface became parallel to the horizontal plane. Based on these observation results, determination was made according to the following evaluation criteria.

### (Evaluation Criteria)

Liquid: The appearance is liquid, no solid state is mixed, and when the cylindrical container containing the electrolytic solution is inclined such that the bottom surface of the container and the horizontal plane form 30°, the liquid surface of the electrolytic solution becomes parallel to the horizontal plane in less than 1 second after inclination.

Sherbet-like: The appearance is a mixture of liquid and solid, and when the cylindrical container containing the electrolytic solution is inclined such that the bottom surface of the container and the horizontal plane form 30°, the liquid surface of the electrolytic solution becomes parallel to the horizontal plane in 1 second or longer and 60 seconds or less after inclination.

Starch-syrup-like: The appearance is a highly viscous liquid, and when the cylindrical container containing the electrolytic solution is inclined such that the bottom surface of the container and the horizontal plane form 30°, the liquid surface of the electrolytic solution changes in its shape but does not become parallel to the horizontal plane in 1 second or longer and 60 seconds or less after inclination.

Solid: The appearance is solid, and when the cylindrical container containing the electrolytic solution is inclined such that the bottom surface of the container and the horizontal plane form 30°, the liquid surface of the electrolytic solution does not change for more than 10 minutes after inclination.

### (2-2. Measurement of Ionic Conductivity)

### —Preparation of Measurement Sample—

The measurement cell produced in (1-3. Preparation of measurement cell) was enclosed in a laminate with a tab electrode to obtain a cell for measuring ionic conductivity as a measurement sample.

### —Measurement of Ionic Conductivity—

The ionic conductivity of the measurement sample was measured using an impedance meter (“VMP3”, manufactured by BioLogic). The ionic conductivity was measured at room temperature (25° C.) with AC impedance method. The solid electrolyte of Example 1 had an ionic conductivity of 4.9×10⁻⁴ (S/cm) in a molar ratio (SN/LiFSI) of 4.0. The results are shown in Table 1 together with the results of appearance observation of the electrolytic solution described above. Table 1 shows the molar ratio (SN/LiFSI), the state of the electrolytic solution at room temperature, and the ionic conductivity at room temperature.

### (2-3. Structural Analysis of Electrolyte by Raman Spectroscopy)

Structural analysis was performed using Raman spectroscopy for the electrolytes of Examples 2, 3, and 5 to 7 and Comparative Example 1 described later.

The solid electrolyte molded in (1-3. Preparation of measurement cell) was used as a measurement sample for structural analysis. The obtained measurement sample was set in a microscopic laser Raman spectrometer (“LabRam HR Evolution”, manufactured by HORIBA, Ltd.). The surface of the measurement sample was irradiated with infrared laser light (wavelength: 1064 nm), and a Raman spectrum was measured using an objective lens having a spot diameter of 7 μm. The Raman spectrum may be measured by irradiating, with infrared laser light, a cut surface formed by cutting the measurement sample (solid electrolyte) for structural analysis.

FIG. 3 shows Raman spectrums of the electrolytes of Examples 2, 3, and 5 to 7 and Comparative Example 1 at 2220 to 2320 cm⁻¹. In the Raman spectrums shown in FIG. 3, the vertical axis represents Raman intensity (unit: arbitrary intensity), and the horizontal axis represents Raman shift (unit: cm⁻¹). The Raman spectrums shown in FIG. 3 had a peak located around 2254 cm⁻¹ and a peak located around 2280 cm⁻¹. The peak located around 2280 cm⁻¹ was assigned to the peak that was derived from CN stretching vibration of the nitrile groups of SN and originally positioned around 2254 cm⁻¹, and that was shifted to the higher wave number side.

### (2-4. Determination of Si/Al Ratio by Nuclear Magnetic Resonance Method)

In Examples 11 to 19 described below, the Si/Al ratio of the zeolite or the mesoporous silica was determined.

Specifically, the zeolite or mesoporous silica was pulverized such that measurement could be performed. The pulverized zeolite or mesoporous silica was placed in a nuclear magnetic resonance apparatus (“ECA 400 type FT-NMR apparatus” manufactured by JEOL Ltd.). An NMR spectrum was measured under measurement conditions of a magnetic field strength of 9.2 T and a nuclide: ²⁹Si. The Si/Al ratio was obtained from the peak area intensity ratio of the ²⁹Si NMR spectrum.

### Examples 2 to 9 and Comparative Examples 1 and 2: Molar Ratio

Electrolytes were prepared and the ionic conductivity was measured in the same manner as in Example 1 except that the molar ratio (SN/LiFSI) was changed from 4.0 to the molar ratios shown in Table 1. In addition, the appearance of the electrolytic solutions obtained in the electrolyte preparation step was also observed. These results are shown in Table 1.

When the concentration of the metal salt is relatively high in the electrolytic solution including the metal salt and the medium (that is, when the concentration of the medium is relatively low), the electrolytic solution may become a solid or a liquid containing precipitated solid at room temperature (25° C.). In such a case, the electrolytic solution was heated (for example, at 90° C.) until the solid in the prepared electrolytic solution was totally dissolved, and the obtained liquid was subjected to impregnation treatment.

In Example 6, a lithium ion secondary battery including the electrolyte of Example 6, Li₄Ti₅O₁₂ as a negative electrode, and LiFePO₄ as a positive electrode was produced. Charge-discharge was performed at a current of 0.1 C (coulomb). The charge-discharge potential was about 1.8 V.

### [Results: Examples 1 to 9 and Comparative Examples 1 and 2: Molar Ratio]

### (Ionic Conductivity)

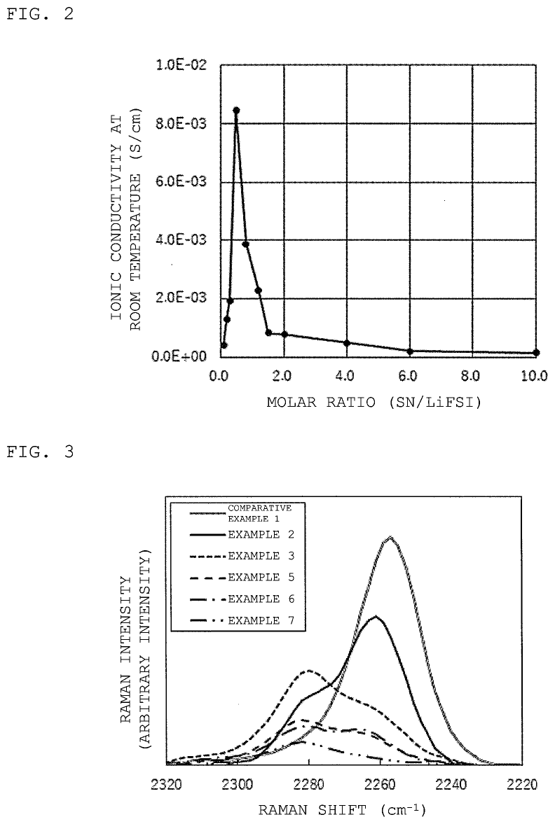

Table 1 shows the molar ratio (SN/LiFSI) and ionic conductivity at room temperature. FIG. 2 was created based on Table 1. FIG. 2 shows the relationship between molar ratio (SN/LiFSI) and ionic conductivity at room temperature. In FIG. 2, the horizontal axis represents molar ratio, and the vertical axis represents ionic conductivity (unit: S/cm) at room temperature. In the scale of the vertical axis in FIG. 2, for example, 1.0E-03 indicates 1.0×10⁻³.

TABLE 1

| | | State of | |
|---|---|---|---|
| | | electrolytic | Ionic |
| | | solution*³ | conductivity |
| | | at normal | at room |
| | Molar ratio | temperature (room | temperature |
| | (SN*¹/LiFSI*²) | temperature) | (S/cm) |
| Comparative | 10.0 | Liquid | 1.5 × 10⁻⁴ |
| Example 1 | | | |
| Comparative | 6.0 | Liquid | 2.0 × 10⁻⁴ |
| Example 2 | | | |
| Example 1 | 4.0 | Sherbet-like | 4.9 × 10⁻⁴ |
| Example 2 | 2.0 | Solid | 7.8 × 10⁻⁴ |
| Example 3 | 1.5 | Solid | 8.2 × 10⁻⁴ |
| Example 4 | 1.2 | Sherbet-like | 23 × 10⁻⁴ |
| Example 5 | 0.8 | Starch-syrup-like | 39 × 10⁻⁴ |
| Example 6 | 0.5 | Starch-syrup-like | 85 × 10⁻⁴ |
| Example 7 | 0.3 | Solid | 19 × 10⁻⁴ |
| Example 8 | 0.2 | Solid | 13 × 10⁻⁴ |
| Example 9 | 0.1 | Solid | 4.1 × 10⁻⁴ |

*¹Succinonitrile,
*²Lithium bis (fluorosulfonyl) imide,
*³Electrolytic solution made of metal salt and medium used in each example

In the SN—LiFSI-based electrolytes, as shown in FIG. 2, the ionic conductivity simply increased at room temperature as the molar ratio (SN/LiFSI) increased from 0.1 to 0.5, the ionic conductivity simply decreased at room temperature as the molar ratio (SN/LiFSI) increased from 0.5 to 4.0, and the ionic conductivity was almost constant at room temperature as the molar ratio (SN/LiFSI) increased from 6.0 to 10.0.

The ionic conductivity of the electrolytic solutions containing SN and LiFSI in Examples 2 and 3 was measured, and each found to be less than or equal to the lower measurement limit (or less than or equal to the measurement limit; more specifically, about 10⁻⁷ S/cm). The value corresponds to the ionic conductivity of an insulator.

### (Bridge Structure)

In the SN—LiFSI-based electrolytes, as shown in FIG. 3, the peak (Raman scattering peak) derived from CN stretching vibration is located around 2254 cm⁻¹ when the molar ratio (SN/LiFSI) is 10.0. When the molar ratio (SN/LiFSI) decreases to become 0.3 to 0.8 and 1.5 to 2.0, the intensity of the peak located around 2254 cm⁻¹ decreases, a peak appears around 2280 cm⁻¹, that is, on the higher wave number side thereof, and the intensity of the peak on the higher wave number side relatively increases. In the electrolytes of Examples 2 and 3 and Examples 5 to 7, the peak derived from CN stretching vibration was shifted to the higher wave number side as compared with the electrolyte of Comparative Example 1.

From these results, it is considered that, in the electrolytes of Examples 2 and 3 and Examples 5 to 7, Li⁺ constituting the metal salt and SN as the medium formed the bridge structure. The bridge structure was presumably due to a specific molar ratio (SN/LiFSI).

### Comparison of Examples 1 to 9 with Comparative Examples 1 and 2

The electrolytes of Examples 1 to 9 included: HS-690 as the porous insulator having a pore; and SN as the medium having two nitrile groups and LiFSI as the metal salt that were disposed in the pore, wherein LiFSI as the metal salt was at least one selected from the group consisting of an alkali metal salt and an alkaline earth metal salt, and the molar ratio of the medium to the metal salt (medium/metal salt) was 0.1 to 4.0. That is, the electrolytes of Examples 1 to 9 are encompassed in the scope of the disclosure.

The ionic conductivity of the electrolytes of Examples 1 to 8 was 4.1×10⁻⁴ to 85×10⁻⁴ S/cm at normal temperature (room temperature).

The electrolytes of Comparative Examples 1 and 2 are not encompassed in the scope of the disclosure. Specifically, in the electrolytes of Comparative Examples 1 and 2, the molar ratio of the medium to the metal salt (medium/metal salt) was more than 4.0.

The ionic conductivity of the electrolytes of Comparative Examples 1 and 2 was 1.5×10⁻⁴ to 2.0×10⁻⁴ S/cm at normal temperature (room temperature).

Examples 1 to 9, each of which is encompassed in the scope of the disclosure, had higher ionic conductivity at normal temperature (room temperature) than Comparative Examples 1 and 2, neither of which is encompassed in the scope of the disclosure.

### Examples 11 to 19: Porous Insulator (Zeolite)

Electrolytes were prepared and batteries were produced in the same manner as in Example 1 except that HS-690 as the porous insulator and the molar ratio were changed to the porous insulators (zeolite) and the molar ratios listed in Table 2, respectively.

In addition, the ionic conductivity was measured in the same manner as in Example 1. These results are shown in Table 2.

TABLE 2

| | | | | Ionic |
|---|---|---|---|---|
| | | Porous insulator | | conductivity |
| | | (zeolite) | | at room |
| | Molar ratio | Product name | Si/Al | temperature |
| | (SN*¹/LiFSI*²) | (type number) | ratio | (S/cm) |
| Example 11 | 0.5 | HS-320 (H) | 5.5 | 8.0 × 10⁻⁴ |
| Example 12 | 0.5 | HS-320 (Na) | 5.5 | 9.1 × 10⁻⁴ |
| Example 13 | 0.5 | HSZ-360HUA | 15 | 17 × 10⁻⁴ |
| Example 14 | 0.5 | HSZ-640HOA | 18 | 19 × 10⁻⁴ |
| Example 15 | 0.5 | HS-642 | 18 | 20 × 10⁻⁴ |
| Example 16 | 0.5 | HSZ-840HOA | 40 | 29 × 10⁻⁴ |
| Example 17 | 0.5 | HSZ-385HUA | 100 | 36 × 10⁻⁴ |
| Example 18 | 0.5 | HSZ-980HOA | 500 | 43 × 10⁻⁴ |
| Example 19 | 0.5 | HSZ-890HOA | 1500 | 46 × 10⁻⁴ |

*¹Succinonitrile,
*²Lithium bis (fluorosulfonyl) imide

The electrolytes of Examples 11 to 19 included: any of HS-320 (H), HS-320 (Na), HSZ-360HUA, HSZ-640HOA, HS-642, HSZ-840HOA, HSZ-385HUA, HSZ-980HOA, and HSZ-890HOA as the porous insulator (zeolite) having a pore; and SN as the medium having two nitrile groups and LiFSI as the metal salt that were disposed in the pore, wherein LiFSI as the metal salt was at least one selected from the group consisting of an alkali metal salt and an alkaline earth metal salt, and the molar ratio of the medium to the metal salt (medium/metal salt) was 0.1 to 4.0. That is, the electrolytes of Examples 11 to 19 are encompassed in the scope of the disclosure.

The ionic conductivity of the electrolyte of each of Examples 11 to 19 was 8.0×10⁻⁴ to 46×10⁻⁴ S/cm at room temperature, and increased as the Si/Al ratio was increased. This trend suggests that: the higher the Si/Al ratio, the more silanol groups present on the pore inner wall of the porous insulator (zeolite), resulting in more hopping sites for carriers (Li⁺).

### Examples 31 to 36: Metal Salt and Medium

Electrolytes were prepared and batteries were produced in the same manner as in Example 1 except that LiFSI as the metal salt, SN as the medium, and the molar ratio (SN/LiFSI) were changed to the metal salts, media, and molar ratios (medium/alkali metal salt) listed in Table 3, respectively. In addition, the ionic conductivity was measured in the same manner as in Example 1. These results are shown in Table 3.

TABLE 3

| | | | | Ionic |
|---|---|---|---|---|
| | | | | conductivity |
| | Metal salt | | Molar ratio | at room |
| | (Alkali | | (Medium/Metal | temperature |
| | metal salt) | Medium | salt) | (S/cm) |
| Example 31 | LiTFSI*¹ | SN*⁶ | 1.5 | 5.2 × 10⁻⁴ |
| Example 32 | LiPF₆*² | SN | 1.5 | 3.9 × 10⁻⁴ |
| Example 33 | LiBF₄*³ | SN | 1.5 | 4.9 × 10⁻⁴ |
| Example 34 | LiClO₄*⁴ | SN | 1.5 | 3.1 × 10⁻⁴ |
| Example 35 | LiFSI*⁵ | GLN*⁷ | 0.5 | 5.2 × 10⁻⁴ |
| Example 36 | LiFSI | ADN*⁸ | 0.5 | 3.0 × 10⁻⁴ |

*¹Lithium bis (trifluoromethanesulfonyl) imide,
*²Lithium hexafluorophosphate,
*³Lithium tetrafluoroborate,
*⁴Lithium perchlorate,
*⁵Lithium bis (fluorosulfonyl) imide,
*⁶Succinonitrile,
*⁷Glutaronitrile,
*⁸Adiponitrile

The electrolytes of Examples 31 to 36 included: HS-690 as the porous insulator having a pore; and any of SN, GLN, and ADN as the medium having two nitrile groups and any of LiTFSI, LiPF₆, LiBF₄, LiClO₄, and LiFSI as the metal salt that were disposed in the pore, wherein the metal salt was at least one selected from the group consisting of an alkali metal salt and an alkaline earth metal salt, and the molar ratio of the medium to the metal salt (medium/metal salt) was 0.1 to 4.0. That is, the electrolytes of Examples 31 to 36 are encompassed in the scope of the disclosure.

### Examples 41 to 48: Porous Insulator (Mesoporous Silica)

Electrolytes were prepared and batteries were produced in the same manner as in Example 1 except that HS-690 as the porous insulator was changed to the porous insulators (mesoporous silica) listed in Table 4.

In addition, the ionic conductivity was measured in the same manner as in Example 1. These results are shown in Table 4.

TABLE 4

| | | | Ionic |
|---|---|---|---|
| | | Porous | conductivity |
| | | insulator | at room |
| | Molar ratio | (Mesoporous | temperature |
| | (SN*¹/LiFSI*²) | silica) | (S/cm) |
| Example 41 | 2.0 | MCM-48 | 3.3 × 10⁻³ |
| Example 42 | 1.5 | MCM-48 | 3.4 × 10⁻³ |
| Example 43 | 0.8 | MCM-48 | 8.1 × 10⁻³ |
| Example 44 | 0.3 | MCM-48 | 3.2 × 10⁻³ |
| Example 45 | 0.2 | MCM-48 | 1.2 × 10⁻³ |
| Example 46 | 0.5 | SBA-15 | 3.9 × 10⁻³ |
| Example 47 | 0.5 | MCM-41 | 4.2 × 10⁻³ |
| Example 48 | 0.5 | SBA-16 | 4.3 × 10⁻³ |

*¹Succinonitrile,
*²Lithium bis (fluorosulfonyl) imide

The electrolytes of Examples 41 to 48 included: any of MCM-48, SBA-15, MCM-41, and SBA-16 as the porous insulator having a pore; and SN as the medium having two nitrile groups and LiFSI as the metal salt that were disposed in the pore, wherein the metal salt was at least one selected from the group consisting of an alkali metal salt and an alkaline earth metal salt, and the molar ratio of the medium to the metal salt (medium/metal salt) was 0.1 to 4.0. That is, the electrolytes of Examples 41 to 48 are encompassed in the scope of the disclosure.

Embodiments of the electrolyte and the battery according to the present disclosure are as follows.
<1> An electrolyte including: a porous insulator having a pore; and a medium having two nitrile groups and a metal salt that are disposed in the pore, wherein the metal salt is at least one of an alkali metal salt and an alkaline earth metal salt, and a molar ratio of the medium to the metal salt (medium/metal salt) is 0.1 to 4.0.
<2> The electrolyte according to <1>, wherein the medium is at least one of succinonitrile, glutaronitrile, and adiponitrile.
<3> The electrolyte according to <1> or <2>, wherein the metal salt is a lithium salt.
<4> The electrolyte according to any one of <1> to <3>, wherein the porous insulator is at least one of a zeolite and a mesoporous silica.
<5> The electrolyte according to any one of <1> to <4>, wherein a positive ion constituting the metal salt is Li⁺, K⁺, Na⁺, or Mg²⁺,
<6> The electrolyte according to any one of <1> to <5>, wherein a negative ion constituting the metal salt is at least one of a bis(fluorosulfonyl)imide ion and a TFSI ion.
<7> The electrolyte according to any one of <1> to <6>, wherein the electrolyte is a solid electrolyte.
<8> The electrolyte according to any one of <1> to <7>, wherein the medium is at least one nitrile-based medium selected from succinonitrile, glutaronitrile, and adiponitrile, and in a Raman spectrum, a peak derived from CN stretching vibration of the nitrile groups is shifted to a higher wave number side.
<9> The electrolyte according to any one of <1> to <8>, wherein the porous insulator is at least one of a zeolite and a mesoporous silica, and the zeolite and the mesoporous silica have a Si/Al ratio of 5 or more.
<10> A battery including the electrolyte according to any one of <1> to <9>.

The battery including the electrolyte according to the present disclosure can be used in various fields in which power storage is assumed. The battery (especially, secondary battery) including the electrolyte of the present disclosure can be used in the fields of electricity, information, and communication in which electric and electronic equipment and the like are used (for example, electric and electronic equipment fields or mobile equipment fields including mobile phones, smartphones, notebook computers and digital cameras, activity meters, arm computers, electronic papers, and wearable devices, and small electronic devices such as RFID tags, card type electronic money, and smartwatches), home and small industrial applications (for example, the fields of electric tools, golf carts, and home, nursing, and industrial robots), large industrial applications (for example, fields of forklifts, elevators, and harbor cranes), transportation system fields (for example, the fields of hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like, although they are illustrative only.

1. An electrolyte comprising:
a porous insulator having a pore; and
a medium having two nitrile groups and a metal salt that are disposed in the pore, wherein
the metal salt is at least one of an alkali metal salt and an alkaline earth metal salt, and
a molar ratio of the medium to the metal salt is 0.1 to 4.0.

2. The electrolyte according to claim 1, wherein the molar ratio of the medium to the metal salt is 0.2 to 2.0.

3. The electrolyte according to claim 1, wherein the molar ratio of the medium to the metal salt is 0.4 to 1.0.

4. The electrolyte according to claim 1, wherein the medium is at least one of succinonitrile, glutaronitrile, and adiponitrile.

5. The electrolyte according to claim 1, wherein the metal salt is a lithium salt.

6. The electrolyte according to claim 5, wherein the lithium salt is a lithium metal salt.

7. The electrolyte according to claim 6, wherein the lithium metal salt is at least one of lithium bis(fluorosulfonyl)imide, lithium bis(trifluoromethanesulfonyl)imide, lithium tetrafluoroborate, and lithium perchlorate.

8. The electrolyte according to claim 1, wherein the porous insulator is at least one of a zeolite and a mesoporous silica.

9. The electrolyte according to claim 1, wherein a positive ion constituting the metal salt is Li⁺, K⁺, Na⁺, or Mg²⁺.

10. The electrolyte according to claim 1, wherein a negative ion constituting the metal salt is at least one of a bis(fluorosulfonyl)imide ion and a bis(trifluoromethanesulfonyl)imide ion.

11. The electrolyte according to claim 1, wherein the electrolyte is a solid electrolyte.

12. The electrolyte according to claim 1, wherein
the medium is at least one nitrile-based medium selected from succinonitrile, glutaronitrile, and adiponitrile, and
in a Raman spectrum, a peak derived from CN stretching vibration of the nitrile groups is shifted to a higher wave number side.

13. The electrolyte according to claim 1, wherein
the porous insulator is at least one of a zeolite and a mesoporous silica, and
the zeolite and the mesoporous silica have a Si/Al ratio of 5 or more.

14. The electrolyte according to claim 13, wherein the Si/Al ratio is 5 to 10,000.

15. A battery comprising the electrolyte according to claim 1.
